(19) United States
(12) Patent Application Publication
(10) Pub. No.: US 2007/0215245 A1
(43) Pub. Date: Sep. 20, 2007

(54) ANTI-DUST STRUCTURE FOR A SLIDING BLOCK OF A LINEAR GUIDEWAY

(75) Inventors: Yun-Yi LIN, Taichung (TW); Hsin-Tsun HSU, Taichung (TW)

Correspondence Address: BANGER SHIA, 204 CANYON CREEK, VICTORIA, TX, 77901, US

(73) Assignee: HIWIN TECHNOLOGIES CORP., Taichung (TW)

(21) Appl. No.: 11/308,357

(22) Filed: Mar. 18, 2006

(51) Int. Cl. B27G 21/00; B27G 19/00

(52) U.S. Cl. 144/251.1

(57) ABSTRACT

An anti-dust structure for a sliding block of a linear guideway comprises a sliding block and a flexible anti-dust strip. A positioning groove is formed in the inner surface of the sliding block and located correspondingly to the upper steel ball groove. The flexible anti-dust strip has a plurality of lip portions that protrude out of the positioning groove, and the lip portions come into contact with the top surface of the rail. In this way, the flexible anti-dust strip can scrape off the grease and dust accumulated on the top surface of the rail at all times, preventing the dust and grease entering the upper steel ball groove via the top surface of the rail, and thus obtaining a better anti-dust function and ensuring the service life of the linear guideway.

### BACKGROUND OF THE INVENTION

1. Field of the Invention

The present invention relates to a linear guideway, and more particularly to an anti-dust structure for a sliding block of a linear guideway, which can use the flexible anti-dust strip to scrape off the grease and dust accumulated on the top surface of the rail at any time, preventing the dust and grease entering the upper steel ball groove via the top surface of the rail, and thus obtaining a better anti-dust function and ensuring the service life of the linear guideway.

2. Description of the Prior Art

Since linear transmission products are being applied more and more widely in the modern industry, various linear transmission mechanisms have widely come into human life, manufacturing factory and high science and technology instruments, such as linear guideway, ball screw, and the like. Particularly in a large-scale precision mechanism are usually installed various large and small ball screws or linear guideway systems. Although the technology for linear transmission element is developing fast, consumers still need the technology to be improved uninterruptedly. Therefore, there are still some problems to be solved. And this desire for constant improvement of technology is particular strong in many high precision mechanism-manufacturing fields (such as wafer process equipment, CNC equipment, etc) that require comparative stability and quiet. Hence, the existing linear mechanism still has some technological blind spots to be improved.

A linear guideway is normally provided in its upper inner surface of the sliding block with an anti-dust structure that is located correspondingly to the upper ball groove for preventing dust or grease from accumulating on the upper surface of the rail. The anti-dust structures commonly seen include the following two types:

A first conventional anti-dust structure disclosed by U.S. Pat. No. 4,918,846 is shown in FIG. 1, a U-shaped anti-dust plate 10 is fixed to the end of the sliding block by screws. The anti-dust plate 10 is made of spring steel and formed by punch forming, and then the lip portion 11 is fixed at either side of the anti-dust plate 10 (can be fixed by bonding method). The method of fixing the plate 10 on the sliding block includes two types: first, drilling a plurality of threaded holes in the sliding block for engaging with the screws of the anti-dust plate 10; second, an oil nozzle structure is formed in the outer end of the sliding block for fixing the anti-dust plate 10. The lip portion 11 is adapted to scrape dust and grease off the top surface of the rail. However, this conventional product is impractical because of the following reasons:

First, in addition to the complicated assembly process, it should use a plurality of screws to fix the anti-dust plate 10, and some anti-dust plates 10 should be fixed by using the oil nozzle structure. Obviously, it is uneconomic since the resultant production cost is pretty high.

Second, the production process is complicated, the producer has to punch the anti-dust plate 10, and then fix the lip portion 11 on it, and the sliding block also needs to be drilled.

Third, the lip portion 11 is easily broken off after bonding, it is impossible to use soft flexible material (soft flexible material is more difficult to be positioned by bonding), therefore, the dust accumulated inside the lip portion 11 still can enter the upper ball groove easily.

Fourth, the lip portion 11 is bonded to the anti-dust plate 10, the lip portion 11 and the anti-dust plate 10 must be replaced together once one of them is broken, and the replacement work requires the user to unscrew the screws with tools. Therefore, the maintenance of the lip portion 11 is not easy.

To solve the abovementioned problems, another conventional anti-dust structure was developed, which is disclosed by U.S. Pat. No. 5,871,282 as shown in FIG. 2. This anti-dust structure is a metal plate 13 directly mounted on the top inner surface of the slide block 12 by screws 16, and a pair of lip portions 14 is integrally formed with the plate 13 during injection molding process. With the injection molding process, the lip portions 14 can be made of flexible material. For obtaining a better positioning effect, the lip portions 14 must be formed by two steps: the harder portion is firstly formed on the plate 13, then the softer layer with flexibility for contacting the top surface of the rail 15 is formed on the harder portion. Although the second conventional anti-dust structure has been improved, it is still not very practical because of the following reasons:

First, it still needs to use the screws 16 to fix the metal plate 13 and the lip portions 14, the resultant production cost is high.

Second, the production process is still complicated despite the assembly is simple, because the lip portions 14 should be formed by two steps, which involves two materials and many processes.

Third, the pair of lip portions 14 is formed by injection molding, it can't be required, and once it is broken, the whole anti-dust system must be replaced, and the replacement work requires the user to unscrew the screws with tools.

Therefore, the maintenance of the lip portion 11 is not easy.

To solve the aforementioned problems, the inventor of this invention, on the basis of the accumulated experience and skills associated with the linear transmission field, develops a simple structured, low cost anti-dust structure with improved anti-dust effect used on a sliding block of a linear guideway.

### SUMMARY OF THE INVENTION

The primary objective of the present invention is to provide a simply structured and low cost anti-dust structure used on a sliding block of a linear guideway.

To achieve the abovementioned objective, the present invention only needs to define a positioning groove in the inner surface of the sliding and the positioning groove is located correspondingly to the upper steel ball groove for accommodation of a flexible anti-dust strip having a plurality of protruding lip portions, by such arrangement, the flexible anti-dust strip can scrape off the grease and dust accumulated on the top surface of the rail at all times, preventing the dust and grease entering the upper steel ball groove via the top surface of the rail. Therefore, the anti-dust structure for a sliding block of a linear guideway of the present invention is really simply structure and low cost.

The secondary objective of the present invention is to provide an anti-dust structure used on a sliding block of a linear guideway that can be easily assembled, maintained and replaced.

To achieve the abovementioned objective, the present invention only needs to use a flexible anti-dust strip can be easily positioned in a positioning groove formed in the inner surface of the sliding block, and the protruding lip portions are integrally formed with the flexible anti-dust strip. Such arrangement allows the user to assemble and replace the anti-dust structure very easily and quickly.

Yet another objective of the present invention is to provide an anti-dust structure for a sliding block of a linear guideway that has a comparatively good positioning and anti-dust effect.

The positioning groove is formed in the inner surface of the sliding and located correspondingly to the upper steel ball groove for accommodation of a ring-shaped flexible anti-dust strip. With its elastic force, the flexible anti-dust strip can be positioned more firmly.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective view of a first conventional U-shaped anti-dust plate;

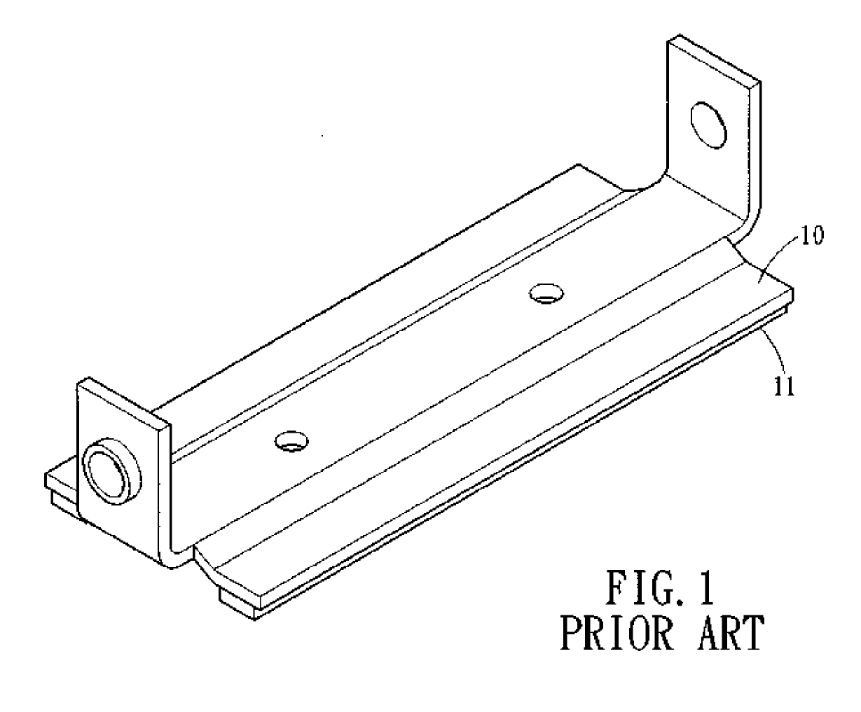

FIG. 2 is a cross sectional view of a second conventional anti-dust structure for a sliding block of a linear guideway;

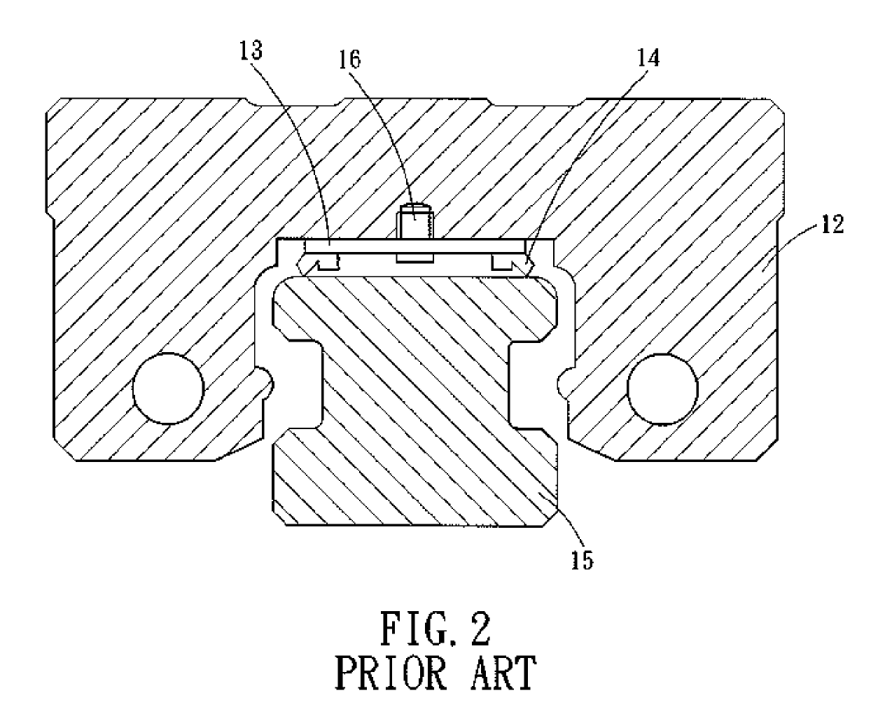

FIG. 3 is an assembly cross sectional view of an anti-dust structure for a sliding block of a linear guideway in accordance with the present invention;

FIG. 4 is a perspective view of showing the inner surface structure of the sliding block in accordance with the present invention;

FIG. 5 is a perspective view of a flexible anti-dust strip in accordance with the present invention; and

FIG. 6 is assembly perspective of the anti-dust structure for a sliding block of a linear guideway in accordance with the present invention.

### DETAILED DESCRIPTION OF THE PREFERRED EMBODIMENT

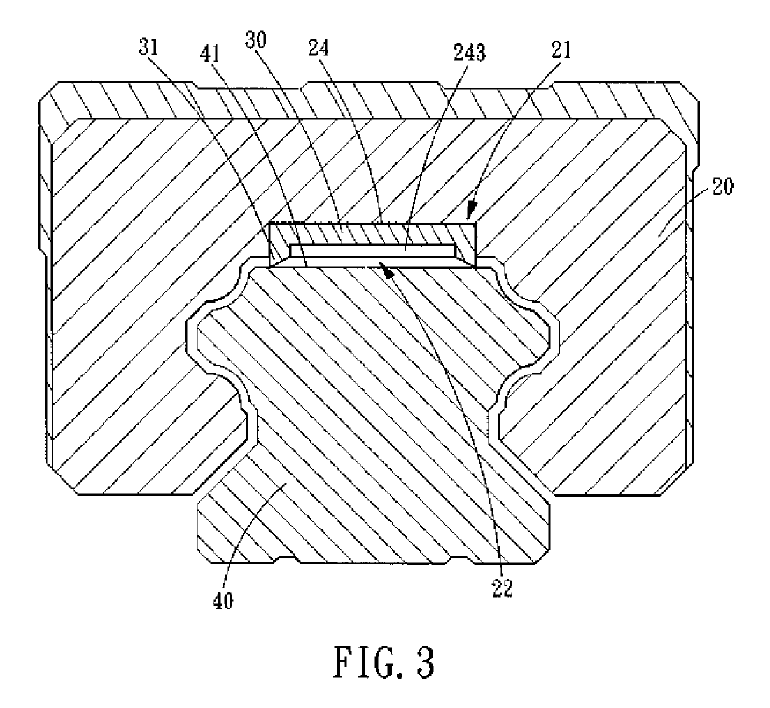

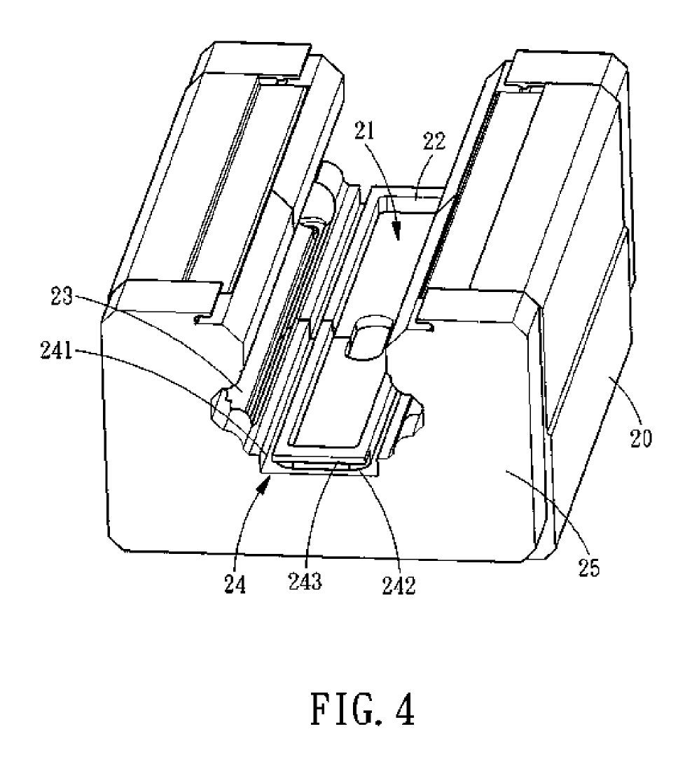

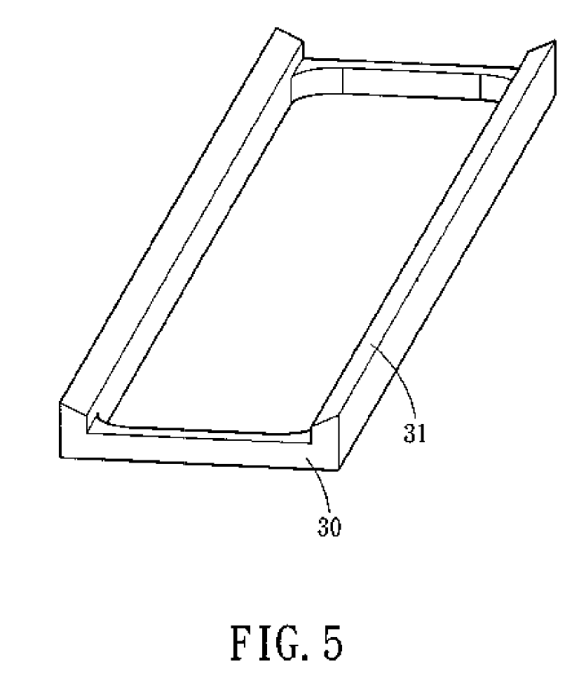

The foregoing, and additional objects, features and advantages of the present invention will become apparent from the following detailed description of preferred embodiment thereof, taken in conjunction with the accompanying FIGS. 3-6.

An anti-dust structure for a sliding block of a linear guideway is fixed on an inner surface 21 of a sliding block 20 slideably mounted on a linear guideway 40. The inner surface 21 is located opposite the top surface 41 of the rail 40. A steel ball retaining portion 22 is assembled on the inner surface 21 of the sliding block 20. A positioning groove 24 is formed in the steel ball retaining portion 22 and includes two longitudinal grooves 241 and two transverse grooves 242. The longitudinal grooves 241 are parallel to the axis of the rail 40, and the two transverse grooves 242 are formed in the inner surface of the end caps 25 fixed at both ends of the sliding block 20. And a protrusion 243 is formed at a lower edge of each of the transverse grooves 242 and protrudes outward therefrom.

A flexible anti-dust strip 30 is in the form of a closed ring, the length and the diameter of the flexible anti-dust strip 30 correspond to the positioning groove 24 of the sliding block 20. The flexible anti-dust strip 30 is formed with two protruding lip portions 31 for mating with the two longitudinal grooves 241 of the sliding block 20, and the flexible anti-dust strip 30 is elastically inserted (or squeezed) in the positioning groove 24 of the sliding block 20 by its elastic force in such a manner that the protruding lip portions 31 protrude out of the two longitudinal grooves 241 until they contact with the top surface 41 of the rail 40. And the flexible anti-dust strip 30 is also inserted (or squeezed) in the two transverse grooves 242 and contacts with the protrusion 243 at the lower edge of the two longitudinal grooves 242. In this way, the flexible anti-dust strip 30 is positioned firmly without falling off.

Whether the flexible anti-dust strip 30 is a closed ring or not is not considered as the most important characteristic of the invention. Unclosed flexible anti-dust strip 30 also can be positioned in the positioning groove 24 of the sliding block 20, and the positioning methods include friction positioning, or the flexible anti-dust tip can be formed with a concave or convex portion for engaging with a concave convex portion of the positioning groove 24, as long as the flexible anti-dust strip 30 will not easily disengage the positioning groove 24.

In addition, the positioning groove 24 of the sliding block 20 can be defined in the inner surface 21, the steel ball retaining portion 22 or in the end caps 25 according to different designs. The present invention does not intend to limit the location of the positioning groove 24, it should be considered as within the scope of the invention as long as the positioning groove 24 is located correspondingly to the contacting the rail 40.

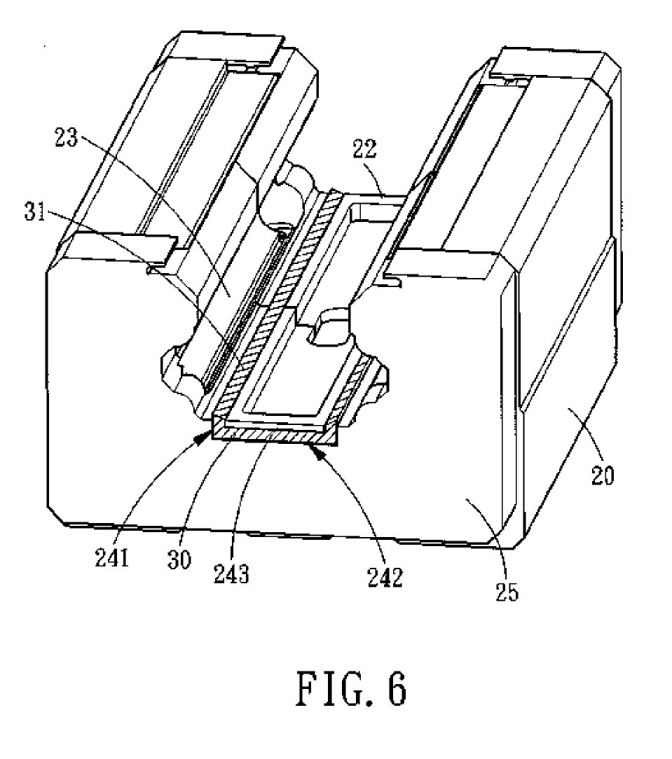

For a better understanding of the preferred embodiment, its operation and function, reference should be made to FIGS. 3 and 6 firstly.

The circular type positioning groove 24 is formed in the end caps 25 and the upper steel ball retaining portion 22. Since the circular positioning groove 24 has two longitudinal grooves 241 and two transverse grooves 242, the longitudinal grooves 241 can limit the transverse movement of the flexible anti-dust strip 30, and the transverse grooves 242 can limit the longitudinal movement of the flexible anti-dust strip 30. Besides, the flexible anti-dust strip 30 firmly contacts with the protrusion 243 at the lower edge of the two transverse grooves 242. In this way, the flexible anti-dust strip 30 is positioned firmly without falling off, therefore, the positioning effect of the present invention is very stable. In operation, the flexible material of the flexible anti-dust strip 30 allows the flexible anti-dust strip 30 to be assembled without the aid of any tools, the user can expands the flexible anti-dust strip 30 outward and then makes it engage in the circular positioning groove 24 (as shown in FIG. 6). After assembly, the protruding lip portions 31 will abut against the top surface 41 of the rail 40, effectively preventing greasy dust from entering the upper ball groove 23 via the top surface 41 of the rail 40, and prolonging the service life of the product of the present invention.

It will be noted that the linear guideway more and more used on manufacturing equipments truly needs a more simply structured anti-dust structure, otherwise, the production cost will be too high and will obstruct the advancement of the linear guideway industry. The present invention only needs to define a positioning groove in the inner surface of the sliding and the positioning groove is located correspondingly to the upper steel ball groove for accommodation of a protruding lip portion, by such arrangement, the flexible anti-dust strip can scrape off the grease and dust accumulated on the top surface of the rail at all times, preventing the dust and grease entering the upper steel ball groove via the top surface of the rail. Therefore, the anti-dust structure for a sliding block of a linear guideway of the present invention is really simply structure and low cost.

To summarize, the innovated design of the present invention includes a sliding block and a flexible anti-dust strip. A positioning groove is formed in the inner surface of the sliding block and located correspondingly to the upper steel ball groove. The flexible anti-dust strip has a plurality of lip portions that protrude out of the positioning groove, and the lip portions come into contact with the top surface of the rail. In this way, the flexible anti-dust strip can scrape off the grease and dust accumulated on the top surface of the rail at all times, preventing the dust and grease entering the upper steel ball groove via the top surface of the rail, and thus obtaining a better anti-dust function and ensuring the service life of the linear guideway.

While we have shown and described various embodiments in accordance with the present invention, it should be clear to those skilled in the art that further embodiments may be made without departing from the scope of the present invention.

What is claimed is:

1. An anti-dust structure for a sliding block of a linear guideway comprising:
a sliding block having a positioning groove formed on an inner surface thereof and located correspondingly to an upper steel ball groove of the sliding block, the inner surface of the sliding block being located opposite a top surface of a rail; and
at least a flexible anti-dust strip sized to correspond to the dimension of the positioning groove of the sliding block, the flexible anti-dust strip being integrally formed with a plurality of protruding lip portions for mating with the positioning groove, and the flexible anti-dust strip being elastically inserted in the positioning groove of the sliding block by its elastic force in such a manner that the protruding lip portions protrude out of the positioning groove and contact with the top surface of the rail.

2. The anti-dust structure for a sliding block of a linear guideway as claimed in claim 1, wherein:
the positioning groove formed in the inner surface of the sliding block is circular, and is comprised of two longitudinal grooves and two transverse grooves, the longitudinal grooves are parallel to an axis of the rail, and the two transverse grooves are transversely formed in both ends of the sliding block; and
a flexible anti-dust strip in the form of a closed ring, the length, and the protruding lip portions are formed on the flexible anti-dust strip for mating with the two longitudinal grooves of the sliding block.

3. The anti-dust structure for a sliding block of a linear guideway as claimed in claim 2, wherein a steel ball retaining portion is assembled on the inner surface of the sliding block, the two longitudinal grooves of the positioning groove are formed in the steel ball retaining portion, and the two transverse grooves of the positioning groove are formed in an inner surface of an end cap fixed at either side of the sliding block.

4. The anti-dust structure for a sliding block of a linear guideway as claimed in claim 2, wherein a protrusion is formed at a lower edge of each of the transverse grooves and protrudes outward therefrom, and the flexible anti-dust strip contacts with the protrusion at the lower edge of the transverse grooves.

5. The anti-dust structure for a sliding block of a linear guideway as claimed in claim 3, wherein a protrusion is formed at a lower edge of each of the transverse grooves and protrudes outward therefrom, and the flexible anti-dust strip contacts with the protrusion at the lower edge of the transverse grooves.

6. The anti-dust structure for a sliding block of a linear guideway as claimed in claim 1, wherein the flexible anti-dust tip is shaped in the form of an unclosed ring and is formed with a concave or convex portion for engaging with a concave convex portion of the positioning groove.
